(19) United States
(12) Patent Application Publication
(10) Pub. No.: US 2013/0298572 A1
(43) Pub. Date: Nov. 14, 2013

(54) CONFIGURATIONS AND METHODS OF VAPOR RECOVERY AND LNG SENDOUT SYSTEMS FOR LNG IMPORT TERMINALS

(71) Applicant: John Mak, Santa Ana, CA (US)

(72) Inventor: John Mak, Santa Ana, CA (US)

(73) Assignee: Fluor Technologies Corporation, Aliso Viejo, CA (US)

(21) Appl. No.: 13/467,317

(22) Filed: May 9, 2012

(51) Int. Cl. F17C 5/02

(52) U.S. Cl. 62/47.1

(57) ABSTRACT

Energy efficiency and stability of LNG sendout operations in LNG terminals is increased by addition of a surge tank and booster pump downstream of a boil-off gas condenser to produce a subcooled condensate that is used to provide refrigeration to an LNG transfer line and that can be fed to the high-pressure LNG sendout pump without impacting the pressure of the main LNG sendout line, and/or without necessitating a pressure reduction device in the main LNG sendout line.

### FIELD OF THE INVENTION

The field of the invention is vapor recovery in liquefied natural gas storage and terminals, especially as it relates to operation and boil-off gas condensation, LNG transfer line cooling, and improvements in LNG sendout systems.

### BACKGROUND

Despite their apparent simplicity, current LNG receiving terminals are faced with various difficulties. For example, increased demands in the market have forced operators to increase the sendout capacities of existing LNG import terminals, and import terminals that were originally designed with an initial capacity of 400 MMscfd are being expanded to deliver 2,000 MMscfd or higher gas supply. In almost all cases, the sendout rates of these high-capacity terminals must be adjusted daily to meet variable demands, requiring frequent shutdown and startup of the sendout pumps. Moreover, the flow of boil-off gas varies from significant quantities during unloading of LNG from a tanker to the storage tank to almost no flow during holding operation. The extreme variations in the sendout rate and the boil-off gas rate pose challenges to the design and operation of today's LNG terminals.

For example, most LNG terminals are designed to recover the boil-off gas evolved during the ship unloading operation. Boil-off gas may be derived comes from various sources, including volumetric displacement of the unloaded LNG, heat leak from the environment, energy input from unloading pumps, and flashed vapors due to the pressure difference between the ship and the storage tanks The boil-off gas is typically recovered by a recovery system that often includes a boil-off gas compressor and a condenser column. However, during the holding operation, net vapor generation is very low or even negative, especially at high sendout rates (e.g., over 500 MMscfd).

Moreover, during the holding operation, the LNG transfer line is stagnant and heat leaks tend to raise the line temperature, resulting in thermal stress. In addition, the LNG transfer line from the LNG unloading docks and LNG storage tanks are often separated by relatively long distances (e.g., as much as 3 to 5 miles), which in most cases requires cooling to maintain the cryogenic temperatures. In a conventional terminal, the transfer line is cooled by diverting a slip stream from the LNG sendout using a flow control valve, which creates a pressure drop in the sendout system. However, this imposes an energy efficiency penalty. Worse yet, such cooling also renders the LNG sendout system more prone to instability and operator errors.

In most known configurations and methods, condensate from the boil-off gas condenser is fed directly to the High Pressure (HP) sendout pump. Thus, any changes in the recondenser pressure and/or liquid levels will also change the HP sendout pump suction pressure, while the HP sendout pump suction pressure is also controlled by the LNG bypass around the condenser. This may cause instability problems in the HP sendout pumps, especially if changes in pressure and/or liquid levels lower the NPSH (Net Pressure Suction Head) of the HP pump beyond the minimum requirement. Insufficient NPSH is known to cause pump cavitation and pump damage as well as vibration.

Alternatively, vapor control can be implemented using a reciprocating pump in which the flow rate and vapor pressure control the proportion of cryogenic liquid and vapor supplied to the pump as described in U.S. Pat. No. 6,640,556 to Ursan et al. However, such configurations are often impractical and typically fail to eliminate the need for vapor compression in LNG receiving terminals, and almost impossible to be integrated to a HP LNG sendout system. These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

In still further known systems and methods, an LNG recirculation system and boil-off gas system can be configured to provide flashed vapor to eliminate the vapor return line for the ship unloading operation, as described in U.S. Pat. No. 8,117,852 to Mak. While such system can eliminate the cost of the vapor line, it has not solved the LNG transfer line cooling requirement during holding operation or the control instability problem associated with operating the boil-off gas condenser and HP sendout pump system as a common system.

In another system, a turboexpander-driven compressor may be employed as described in U.S. Pat. No. 6,460,350 to Johnson et al. Here the energy requirement for vapor recompression is typically provided by expansion of a compressed gas from another source. However, where compressed gas is not available from another process, such configurations are typically not implemented. Such configuration is also deemed impracticable for installation in today's large LNG terminals. In still other known systems, methane product vapor is compressed and condensed against an incoming LNG stream as described in published U.S. Pat. App. No. 2003/0158458. While such systems increase the energy efficiency as compared to other systems, various disadvantages nevertheless remain. For example, vapor handling in such systems is often complex and requires costly vapor compression equipment, and will typically fail to achieve a stable sendout system pressure.

In yet another system, as described in U.S. Pat. No. 6,745,576, mixers, collectors, pumps, and compressors are used for re-liquefying boil-off gas in an LNG stream. In this system, the atmospheric boil-off vapor is compressed to a higher pressure using a vapor compressor such that the boil-off vapor can be condensed. While such a system typically provides improvements on control and mixing devices in a vapor condensation system, stable pressure to the HP sendout pump suction is generally not achieved and so inherits most of the disadvantages of other known configurations.

Thus, all or almost of the currently known LNG import terminals require boil-off gas condensation, LNG transfer line cooling, and LNG sendout pumps that are inherently difficult to control and are energy inefficient, particularly when operating under a high turndown condition. Therefore, there is still a need for improved configurations and methods for the design of the LNG import terminal to reduce energy demands and to provide a safe and stable operation.

### SUMMARY OF THE INVENTION

The inventive subject matter is directed to devices, systems, and methods for boil-off gas condensation and LNG processing in which a surge tank and a booster pump are provided at a location downstream of a boil-off gas condenser to produce a subcooled condensate. The so produced subcooled condensate is then available for refrigeration of an LNG transfer line and for feeding the high-pressure LNG sendout pump without impacting the pressure of the LNG stream that flows from the LNG storage tank to the high-pressure LNG sendout pump. Moreover, use of the booster pump also effectively eliminates the need for a pressure reduction device in the LNG stream that flows from the LNG storage tank to the high-pressure LNG sendout pump.

In one aspect of the inventive subject matter, a boil-off gas condenser system is contemplated for use in an LNG terminal having a high-pressure LNG sendout pump and an LNG storage tank that is fluidly coupled to an LNG transfer line for receiving LNG from an LNG source. Especially preferred systems include a boil-off gas condenser that is fluidly coupled to a surge tank and a booster pump such that the boil-off gas condenser provides condensate to the surge tank and such that the booster pump receives the condensate from the surge tank. A first conduit is fluidly coupled to the booster pump and configured to provide condensate to the LNG transfer line, and a second conduit is fluidly coupled to the booster pump and configured to provide condensate to the high-pressure LNG sendout pump.

Most preferably, the boil-off gas condenser is also fluidly coupled to the LNG storage tank and the LNG transfer line such that the boil-off gas condenser receives a mixture of LNG from an LNG storage tank and LNG from the LNG transfer line. It is still further preferred that the booster pump is configured such that the condensate leaving the booster pump is a subcooled liquid, and/or that the discharge pressure of the condensate from the booster pump is sufficient to move the condensate to and from the LNG source via the transfer line (most typically to allow combination of the condensate with an LNG stream from the LNG storage tank to the high-pressure LNG sendout pump without use of a pressure reduction device acting upon the LNG stream from the LNG storage tank).

In further preferred aspects, the surge tank is fluidly coupled to the high-pressure LNG sendout pump to receive a kickback liquid (minimum flow of pump) from the high-pressure LNG sendout pump, and most preferably has a volume sufficient to receive the kickback liquid from the high-pressure LNG sendout pump without backing up of the kickback liquid into the boil-off gas condenser. Moreover, it is generally preferred that the surge tank has a volume that is sufficient to store at least one of the condensate, LNG from the LNG storage tank, and kickback liquid during a time required for startup or shutdown of the high-pressure LNG sendout pump.

Therefore, particularly preferred methods of using condensate from a boil-off gas condenser in an LNG terminal will include a step of condensing in a boil-off gas condenser boil-off gas from an LNG storage tank to produce a condensate. The condensate is then received in a surge tank, and pressure of the condensate is increased via a booster pump to thereby produce a subcooled condensate. In yet another step, the subcooled condensate is fed an LNG transfer line to thereby maintain cryogenic conditions in the LNG transfer line, and/or a high-pressure LNG sendout pump.

In especially preferred aspects of contemplated methods, the step of condensing is performed using compressed boil-off gas and a mixture of LNG from an LNG storage tank and LNG from the LNG transfer line. As noted before, it is also preferred that the pressure of the condensate is sufficient to move the condensate through the LNG transfer line, and/or that the pressure of the condensate is sufficient to allow combining the condensate with an LNG stream from the LNG storage tank to the high-pressure LNG sendout pump without use of a pressure reduction device acting upon the LNG stream from the LNG storage tank. In still further preferred aspects, a surge tank is used to receive a kickback liquid from the high-pressure LNG sendout pump, and/or to store the condensate and/or the LNG from the LNG storage tank during a time required for startup or shutdown of the high-pressure LNG sendout pump.

Consequently, a method of stabilizing operation of a high-pressure LNG sendout pump is also contemplated that includes a step of using a low-pressure pump to feed LNG from an LNG storage tank to the high-pressure LNG sendout pump, and a further step of using a booster pump to feed condensate of a boil-off gas condenser to the high-pressure LNG sendout pump. In such methods, it is typically preferred that the booster pump produces a pressure (e.g., at least 100 psig) in the condensate effective to subcool the condensate and that allows feeding of the LNG to the high-pressure LNG sendout pump without pressure drop when the condensate is fed to the high-pressure LNG sendout pump.

Most typically, the LNG from the LNG storage tank is combined with an LNG stream from an LNG transfer line, wherein the LNG stream from an LNG transfer line is used for cooling the LNG transfer line. In yet further preferred aspects of contemplated methods, the booster pump is fluidly coupled to a surge tank that receives the condensate from the boil-off gas condenser. Preferably, the surge tank is fluidly coupled to the high-pressure LNG sendout pump to receive a kickback liquid from the high-pressure LNG sendout pump. While not limiting to the inventive subject matter, it is further contemplated that the pressure in the boil-off gas condenser is used to control a flow ratio between boil-off gas from the LNG storage tank and the LNG from the LNG storage tank.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

Prior Art FIG. 1 is an exemplary schematic of a known LNG terminal with LNG transfer line cooling comprising a boil-off gas condenser and an LNG sendout system.

FIG. 2 is an exemplary schematic of a LNG terminal with LNG transfer line cooling comprising a boil-off gas condenser and an LNG sendout system according to the inventive subject matter.

### DETAILED DESCRIPTION

The present invention is directed to various configurations and methods for cooling LNG transfer lines in an LNG receiving terminal in which boil-off gas is condensed and pumped using a booster pump and in which the subcooled condensate used as the cooling medium. In further preferred aspects, the subcooled condensate is received in a surge tank from which the subcooled condensate is fed to the LNG transfer lines and the HP sendout pump. Using such configurations, various advantages are realized.

For example, it should be appreciated that the LNG flowing to the HP sendout pump is significantly subcooled, avoiding thermal stress on the long LNG transfer lines during normal holding operation by maintaining the lines at cryogenic temperatures, hence eliminating the stability problems associated with operation of the HP sendout pump. Moreover, it should be appreciated that the use of the booster pump minimizes pressure drop in the LNG sendout line and saves at least 5% of the pumping energy in the regasification terminal, while the surge tank of the booster pump acts as a surge drum for the HP sendout pump during pump startup or shutdown of the HP sendout pump.

More particularly, it is generally preferred that LNG is provided from LNG storage tanks with low-pressure (LP) in-tank pumps that are fluidly coupled to the HP sendout pumps, while the boil-off gas from the storage tanks is compressed in a boil-off gas compressor and condensed with LNG in a boil-off gas condenser. As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. The boil-off gas condenser produces a saturated liquid of which one portion is pumped by a booster pump to the HP sendout pump suction header, and of which another portion is pumped to and through the LNG transfer lines to so provide at least some cooling to the LNG transfer line (that typically run from the LNG storage tank to the LNG source, typically an unloading dock). The subcooled LNG liquid removes the heat gain in the LNG transfer line from the environment and is returned to the HP sendout pump suction in a subcooled state. Thus, evolution of vapor from the LNG transfer lines due to heat leaks is advantageously avoided, eliminating the potential damage from thermal stress. Moreover, it should be recognized that as the returned liquid from the transfer line cooling is subcooled and mixed with the sendout LNG to the HP sendout pumps, a stable pressure to the pump suction can be maintained.

To illustrate the advantages over previously known configurations and methods, a typical prior art LNG unloading terminal is shown in Prior Art FIG. 1. Here, LNG at about −255° F. is pumped from the storage tank 55 to 220 psig, using an in-take pump 54 at a flow rate of 1,000 MMscfd (9,500 GPM), forming stream 10. Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

To cool the main LNG transfer line 1, about 300 GPM flow is diverted to the unloading dock area 51 using a flow control valve 58 using a small circulation line 2. The heat gain from the LNG transfer line raises the recirculated LNG by about 20° F. forming stream 5 at about −230° F. which is mixed with the LNG sendout stream 11, forming the mixed stream 13. A pressure reducing valve 57 is used to lower the line pressure from 220 psig to about 130 psig, which is necessary to allow the returning of the recirculation flow stream 5. It should be noted that this recirculation configuration requires a significant pressure reduction in the main line from LP pump 54 to HP pump 64, which represents a significant loss in pumping energy.

Stream 13 is split into two portions: one portion stream 14 at about 1,000 GPM is used to condense the boil-off gas from in the condenser 59, and the remaining portion stream 15 is further dropped in pressure control valve 61, which controls the suction pressure of the HP sendout pump, typically at 100 psig. The LNG flow to the condenser is controlled by a flow valve 60, which is controlled by a mass ratio of liquid to vapor, typically set at 7. However, the condenser pressure depends on the amount of cooling with the LNG, which in turns depends on the LNG and boil-off gas compositions and temperatures; and hence, a constant flow ratio does not guarantee a constant pressure. This pressure instability plus the variable liquid level (liquid head) has a significant impact on the HP sendout pump suction pressure at stream 17.

The condenser bottom stream 16 is mixed with the stream 17 and fed to the HP sendout pump 64. Since there is a lack of surge in the pump suction for mixing, the mixture arriving in the pump suction contains some vapor, which causes instability and potential pump cavitation. The lack of surge also creates problems during pump startup and shutdown, as pump kickback flow stream 19, which is typically set at 20% of the pump design flow, will flood the condenser, disrupting the condensation process. For this reason, such process configurations will encounter problems during change from holding to unloading operation (and vice versa). The HP sendout pump discharge at 1400 psig forming stream 18 and under normal operation is heated by vaporizer 65 to about 40° F. forming stream 20, as sales gas to the pipeline.

In view of the above, it should be appreciated that the configurations and methods of Prior Art FIG. 1 require substantial energy for recirculating the sendout LNG from the sendout header to the unloading dock areas. Moreover, control system for configurations and methods of Prior Art FIG. 1 do not guarantee a stable pressure to the HP sendout pump, making transient operation difficult, as the operation of the condenser has an impact on the pump suction pressure.

In contrast, contemplated configurations and methods alleviate the above problems by subcooling the boil-off gas condensate by pumping, and using the refrigeration content of the boil-off gas condensate for cooling the LNG transfer line. Thus, preferred configurations include a LP sendout pump that is configured to provide an LNG stream from the LNG storage tank and that is fluidly coupled to a HP LNG sendout pump, and a boil-off gas condenser that condenses the boil-off gas and provides a subcooled liquid LNG to the HP sendout pump. A compressor and a condenser are fluidly coupled to the LNG storage tank and configured to receive the LNG vapor and to thus provide a pressurized saturated LNG liquid. Most preferably, a booster pump is installed in a suction drum and is configured such that the booster pump discharge pressure will meet the pressure requirements for recirculation to and from the unloading dock via the LNG transfer line, without impacting the pressure of the main LNG sendout line, and such that a pressure reduction device (e.g., JT valve, expansion turbine, etc.) is not required on the sendout line, which will advantageously minimize the pressure drop. Most preferably, a booster pump suction drum is fluidly coupled to and located downstream of the condenser and configured to operate as a surge tank to receive the pump kickback liquid from the HP sendout pump during pump start and shutdown operation. Thus, the surge tank provides a buffer to the pressure and flow fluctuation, ensuring a stable operating system.

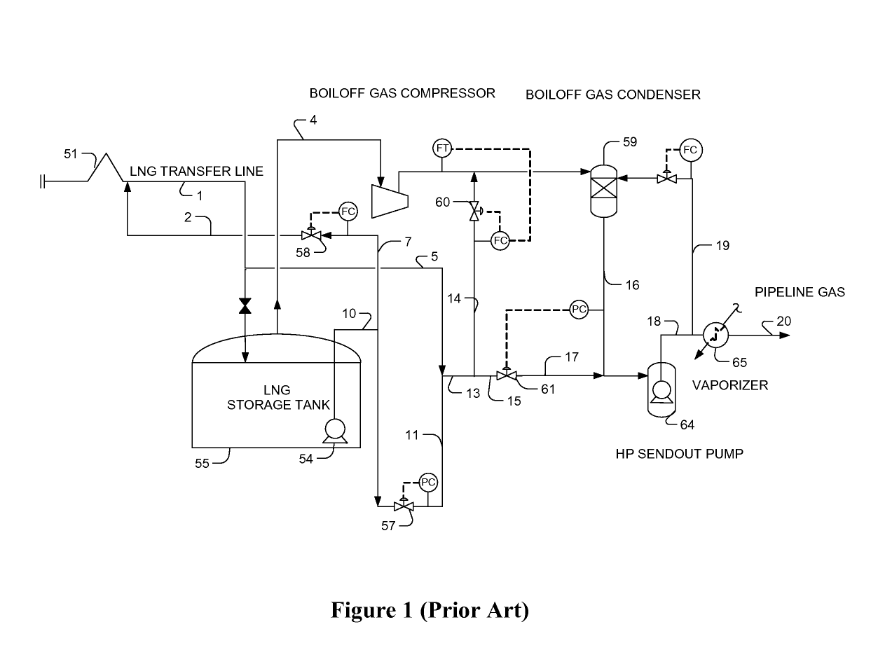

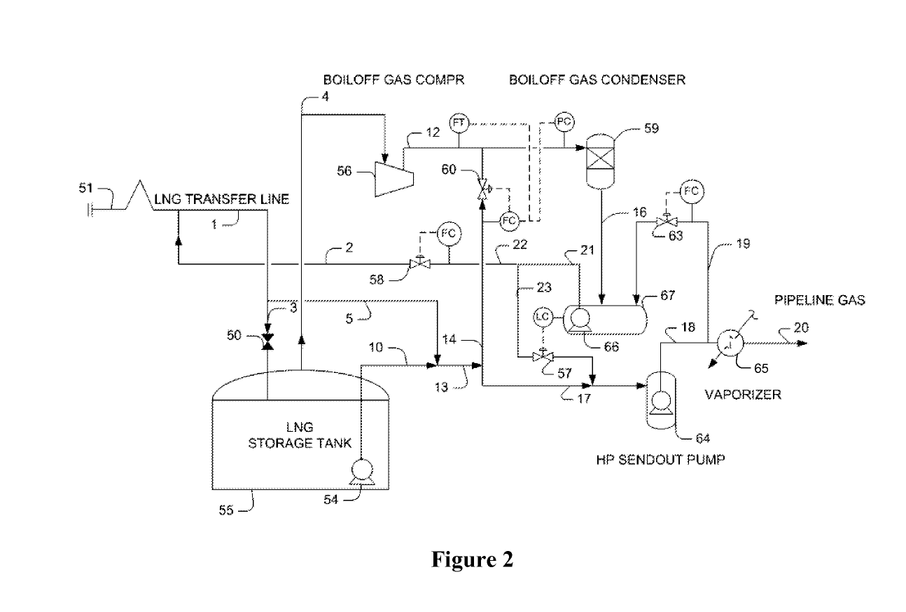

One exemplary configuration according to the inventive subject matter is depicted in FIG. 2 in which an LNG transfer line is coupled to an LNG circulation system. In such circulation system, a portion of the boil-off gas condensate is pumped and used for cooling the LNG transfer line from the LNG docking area to the LNG storage area, without interfering with the main LNG sendout flow path, which avoids line thermal stress and potential operation problems. Among other advantages, it should be recognized that contemplated configurations and methods maintain a subcooled liquid to the HP sendout pump and also substantially decrease the capital and energy requirements.

More specifically, LNG is provided (typically from an LNG transporter, not shown) via transfer lines 1 and 3, and valve 50 to the storage tank 55. Boil-off gas is fed via line 4 to the boil-off gas compressor 56 that provides compressed boil-off gas 12 and mixed stream 14 to the recondenser 59. LNG at about −255° F. is pumped from the storage tank 55 to 220 psig, using an in-tank pump 54 at a flow rate of 1,000 MMscfd (9,500 GPM), forming stream 10. To cool the main LNG transfer line 1, the condensate from the condensate surge tank 67 is pumped by booster pump 66, at a rate of about 1000 GPM forming stream 21, and split into two portions: stream 22 and 23. Stream 22 at about 300 GPM is sent to the unloading dock area 51 using a flow control valve 58 via a small circulation line 2. The heat gain from the LNG transfer line raises the recirculated LNG by about 5 to 20° F. forming stream 5 at about −230° F. which is mixed with the LNG sendout stream 10, forming the mixed stream 13, which is further split into two portions: stream 14 and stream 17. Stream 14 at about 1,000 GPM is letdown in pressure to the condenser 59 which is controlled by a flow valve 60, which is controlled by a mass ratio of liquid to vapor, typically set at 7. The condenser pressure is maintained at a constant pressure by resetting the flow ratio controller. The recondenser pressure depends on the amount of cooling with the LNG, which in turns depends on the LNG and boil-off gas compositions and temperatures; and hence, a flow ratio is adjusted as necessary to maintain a constant pressure, ensuring stability of the condenser operation. In all operation, the condenser packing is not flooded with liquid as in the prior design. The condensate is drained to a lower drum 67 via line 16 and is pumped by booster pump 66 for line cooling and to mix with the main sendout LNG to the HP sendout pump 64. Stream 18 from the HP sendout pump 64 is then fed to the vaporizer 65 for vaporization and delivery as pipeline gas 20. Pump kickback flow stream 19 is fed back to the surge tank 67 via flow control valve 63. The pump suction surge tank has a capacity to hold the surge volume required for the HP sendout pump operation, during startup or shutdown, which will help to flash off any gas content and ensure that the pump suction liquid remains subcooled, thus eliminating the instability in heretofore known methods and configurations.

Consequently, it should be recognized that various benefits are realized by configurations and methods that employ boil-off gas condensate for cooling the LNG transfer lines, especially where subcooled LNG is fed by a booster pump to the HP sendout pump, which so maintains a constant pressure at the HP sendout pump suction, which in turn reduces energy consumption and improves operational stability of the sendout system. While many alternative configurations are deemed suitable for use herein, it is generally preferred that the boil-off gas from the storage tanks is compressed by a compressor and condensed by contacting the boil-off gas with a portion of the LP sendout LNG in a condenser vessel under a flow ratio controller that is reset by the condenser pressure. Likewise, it is generally preferred that the boil-off gas condensate is drained from the condenser to a surge tank equipped with a booster pump that pressurizes the condensate by a pressure (e.g., at least 100 psi) that is effective to produce a subcooled liquid that is suitable for cooling the transfer line and for mixing with the sendout LNG. Thus, and viewed from yet another perspective, the HP sendout pump is directly fed by the LP sendout pump and boil-off gas condensate, without installation of control valve on the sendout header, which eliminates a pressure drop otherwise present in the main header of heretofore known systems and methods.

Additionally, it should be recognized that the surge tank will not only operate as a suction drum to the booster pump, but may also be used to receive and temporarily store condensate, which will avoiding flooding of the condenser packing, without interfering with the condensation operation. Level control in the surge tank can be achieved using a control valve on the booster pump discharge. Additionally, the surge tank capacity can also be adjusted to hold the kickback flow during HP pump startup or shutdown or under upset conditions, thus stabilizing the sendout system.

Consequently, a method of transferring an LNG stream from a LNG source (e.g., LNG storage tank) includes a step of forming a pressurized saturated LNG liquid from the boil-off gas from LNG storage tanks, and another step of pumping the saturated LNG and circulating a portion of the pressurized LNG for cooling the LNG transfer lines. Most typically, the circulating LNG is at least 50 to 100 psi subcooled such that the combined stream with the main sendout LNG has adequate NPSH and pressure to feed the HP sendout pumps. Viewed from another perspective, the boil-off gas condenser pressure is at least 50 to 100 psi lower than the HP sendout pump suction such the HP pump inlet streams are completely subcooled, avoiding formation of two phases to the pump suction and pump cavitation often experienced in heretofore known processes. Further aspects, contemplated configurations and methods suitable for use in conjunction with the teachings presented herein are found in WO 2005/045337 and WO 2007/120782, which are incorporated by reference herein.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A boil-off gas condenser system for use in an LNG terminal having a high-pressure LNG sendout pump and an LNG storage tank that is fluidly coupled to an LNG transfer line for receiving LNG from an LNG source, comprising:
a boil-off gas condenser fluidly coupled to a surge tank and a booster pump such that the boil-off gas condenser provides condensate to the surge tank and such that the booster pump receives the condensate from the surge tank;
a first conduit fluidly coupled to the booster pump and configured to provide condensate to the LNG transfer line; and
a second conduit fluidly coupled to the booster pump and configured to provide condensate to the high-pressure LNG sendout pump.

2. The boil-off gas condenser system of claim 1 wherein the boil-off gas condenser is fluidly coupled to the LNG storage tank and the LNG transfer line such that the boil-off gas condenser receives a mixture of LNG from an LNG storage tank and LNG from the LNG transfer line.

3. The boil-off gas condenser system of claim 1 wherein the booster pump is configured such that the condensate leaving the booster pump is a subcooled liquid.

4. The boil-off gas condenser system of claim 1 wherein the booster pump is configured such that a discharge pressure of the condensate from the booster pump is sufficient to move the condensate to and from the LNG source via the transfer line.

5. The boil-off gas condenser system of claim 4 wherein the discharge pressure is sufficient to allow combination of the condensate with an LNG stream from the LNG storage tank to the high-pressure LNG sendout pump without use of a pressure reduction device acting upon the LNG stream from the LNG storage tank.

6. The boil-off gas condenser system of claim 1 wherein the surge tank is further fluidly coupled to the high-pressure LNG sendout pump to receive a kickback liquid from the high-pressure LNG sendout pump.

7. The boil-off gas condenser system of claim 6 wherein the surge tank has a volume that is sufficient to receive the kickback liquid from the high-pressure LNG sendout pump without backing up of the kickback liquid into the boil-off gas condenser.

8. The boil-off gas condenser system of claim 1 wherein the surge tank has a volume that is sufficient to store at least one of the condensate, LNG from the LNG storage tank, and pump kickback during a time required for startup or shutdown of the high-pressure LNG sendout pump.

9. A method of using condensate from a boil-off gas condenser in an LNG terminal, comprising:
condensing in a boil-off gas condenser boil-off gas from an LNG storage tank to produce a condensate;
receiving the condensate in a surge tank, and increasing pressure of the condensate via a booster pump to thereby produce a subcooled condensate; and
feeding the subcooled condensate to at least one of (1) an LNG transfer line to thereby maintain cryogenic conditions in the LNG transfer line and (2) a high-pressure LNG sendout pump.

10. The method of claim 9 wherein the step of condensing is performed using compressed boil-off gas and a mixture of LNG from an LNG storage tank and LNG from the LNG transfer line.

11. The method of claim 9 wherein the pressure of the condensate is sufficient to move the condensate through the LNG transfer line.

12. The method of claim 9 wherein the pressure of the condensate is sufficient to allow combining the condensate with an LNG stream from the LNG storage tank to the high-pressure LNG sendout pump without use of a pressure reduction device acting upon the LNG stream from the LNG storage tank.

13. The method of claim 9 further comprising a step of receiving in the surge tank a kickback liquid from the high-pressure LNG sendout pump.

14. The method of claim 9 further comprising a step of storing in the surge tank at least one of the condensate, LNG from the LNG storage tank, and pump kickback during a time required for startup or shutdown of the high-pressure LNG sendout pump

15. A method of stabilizing operation of a high-pressure LNG sendout pump, comprising:
using a low-pressure pump to feed LNG from an LNG storage tank to the high-pressure LNG sendout pump;
using a booster pump to feed condensate of a boil-off gas condenser to the high-pressure LNG sendout pump;
wherein the booster pump produces a pressure in the condensate effective to subcool the condensate and to allow feeding of the LNG to the high-pressure LNG sendout pump without pressure drop when the condensate is fed to the high-pressure LNG sendout pump.

16. The method of claim 15 wherein the LNG from the LNG storage tank is combined with an LNG stream from an LNG transfer line, and wherein the LNG stream from an LNG transfer line is used for cooling the LNG transfer line.

17. The method of claim 15 wherein the booster pump is fluidly coupled to a surge tank that receives the condensate from the boil-off gas condenser.

18. The method of claim 17 wherein the surge tank is fluidly coupled to the high-pressure LNG sendout pump to receive a kickback liquid from the high-pressure LNG sendout pump.

19. The method of claim 15 wherein pressure in the boil-off gas condenser is used to control a flow ratio between boil-off gas from an LNG storage tank and the LNG from the LNG storage tank.

20. The method of claim 15 wherein the pressure is at least 100 psig.
